(19) United States
(12) Patent Application Publication
(10) Pub. No.: US 2023/0406988 A1
(43) Pub. Date: Dec. 21, 2023

(54) METHOD FOR USING DISULFIDE REACTIVE CHEMICAL ON POLYURETHANE FOAM TO IMPROVE REPROCESSABILITY IN HOT PRESS PROCESS WITH SUPERIOR RECYCLING RATE

(71) Applicants: Ford Motor Company, Dearborn, MI (US); Washington State University, Pullman, WA (US)

(72) Inventors: Alper Kiziltas, Sarikamis (TR); Deborah Frances Mielewski, Ann Arbor, MI (US); Wangcheng Liu, Pullman, WA (US); Jinwen Zhang, Pullman, WA (US)

(73) Assignees: Ford Motor Company, Dearborn, MI (US); Washington State University, Pullman, WA (US)

(21) Appl. No.: 17/845,265

(22) Filed: Jun. 21, 2022

(51) Int. Cl. C08G 18/08; C08G 18/48; C08G 18/38

(52) U.S. Cl. CPC C08G 18/14; C08G 18/4829; C08G 18/3855; C08G 2101/00

(57) ABSTRACT

A recyclable polyurethane foam is produced by reacting a disulfide reactive chemical-based polyol-containing composition and an isocyanate composition. The polyurethane foam may include a molar ratio of the disulfide reactive chemical of greater than or equal to about 2:1 mol %, 4:1 mol %, or 6:1 mol %, wherein the ratio equates to the molar ratio of hydroxyl groups of the disulfide reactive chemical versus the molar ratio of hydroxyl groups of the polyol.

### GOVERNMENT INTERESTS

This invention was made with government support under grant number 1738669 awarded by the National Science Foundation. The government has certain rights in the invention.

### FIELD

The present disclosure relates to recyclable polyurethane foams.

### BACKGROUND

The statements in this section merely provide background information related to the present disclosure and may not constitute prior art.

Conventional methods for developing polyurethane foams typically include reacting a mixture with at least one polyol with hydroxyl groups (such as petroleum-based polyols) with a mixture having at least one isocyanate and/or diisocyanates in the presence of additives, such as blowing agents, surfactants, catalysts, and any other desired additives by forming a gas (e.g., carbon dioxide) while urethane polymerization occurs (the mixture of the polyol mixture, the isocyanate mixture, and any additives is also referred to as a reaction mixture). The polyol mixture can include the additives. The gas is formed as a result of the blowing agent, which typically is water, reacting with the isocyanates, thereby forming carbon dioxide and polyurea. Other additives enhance the properties of the resulting foam, control the aforementioned reactions, and the like.

Polyurethane foams are thermosets and accordingly, at their useful end of life, it may be challenging to reuse such polyurethane foams. Vitrimers are a recently discovered kind of polymeric thermoset material that has plastic-like properties and features under high temperature. More particularly, vitrimers exhibit malleability at high temperatures, allowing for re-arrangement of the macromolecular network and thereby allowing for reprocessability. The carbamate and carbamide bonds of polyurethane are noted to be inherently interchangeable, rendering a degree of rearrangement of the network structure and hence a kind of reprocessability. However, the reprocessing of polyurethane is usually a slow process, especially for those prepared from petroleum-based ether polyols.

These issues related to the design of recyclable polyurethane foams, particularly in automotive applications, are addressed by the present disclosure.

### SUMMARY

This section provides a general summary of the disclosure and is not a comprehensive disclosure of its full scope or all of its features.

According to one form of the present disclosure, a polyurethane foam is produced by reacting a polyol-containing composition and an isocyanate composition. The polyol-containing composition includes greater than or equal to about 9.33 parts by weight percent disulfide reactive chemical to less than or equal to about 28 parts by weight percent disulfide reactive chemical.

In variations of this form, which may be implemented individually or in any combination: the polyurethane foam further includes at least one of a cell opener, a surfactant, a cross-linking agent, a catalyst, a co-catalyst, and a water blowing agent; the polyol-containing composition further includes a cell opener at about 1 parts by weight percent, a surfactant at about 0.5 parts by weight percent, a cross-linking agent at about 1.5 parts by weight percent, a catalyst at greater than or equal to about 0.7 parts by weight percent, a co-catalyst at greater than or equal to about 0.35 parts by weight percent, and a water blowing agent at about 3 parts by weight percent; the polyol-containing composition includes a catalyst at greater than or equal to about 0.7 parts by weight percent to less than or equal to about 0.87 parts by weight percent and a co-catalyst at greater than or equal to about 0.35 parts by weight percent to less than or equal to about 0.44 parts by weight percent; the polyurethane foam has a strength at max of greater than or equal to about 186.9 kPa; the polyurethane foam has a density of greater than or equal to about 56.2 kg/m³; and a vehicle component is formed of the polyurethane foam.

In another form of the present disclosure, a polyurethane foam is produced by reacting a polyol-containing composition and an isocyanate composition. The polyurethane foam includes greater than or equal to about 5.5 parts by weight percent 2-hydroxyethyl disulfide and the polyol-containing composition includes a catalyst at greater than or equal to about 0.7 parts by weight percent to less than or equal to about 0.87 parts by weight percent.

In variations of this form, which may be implemented individually or in any combination: the polyurethane foam further includes at least one of a cell opener, a surfactant, a cross-linking agent, a co-catalyst, and a water blowing agent; the polyol-containing composition further includes a cell opener at about 1 parts by weight percent, a surfactant at about 0.5 parts by weight percent, a cross-linking agent at about 1.5 parts by weight percent, a co-catalyst at greater than or equal to about 0.35 parts by weight percent, and a water blowing agent at about 3 parts by weight percent; the polyol-containing composition includes a co-catalyst at greater than or equal to about 0.35 parts by weight percent to less than or equal to about 0.44 parts by weight percent; the polyurethane foam has a specific modulus of greater than or equal to about 7.20 kNm/kg; the polyurethane foam has a specific strength of greater than or equal to about 3.32 kNm/kg; and a vehicle component is formed of the polyurethane foam.

In yet another form of the present disclosure, a polyurethane foam is produced by reacting a polyol-containing composition and an isocyanate composition. The polyol-containing composition includes 2-hydroxyethyl disulfide, a catalyst at greater than or equal to about 0.7 parts by weight percent, and a co-catalyst at greater than or equal to about 0.35 parts by weight percent.

In variations of this form, which may be implemented individually or in any combination: the polyurethane foam further includes at least one of a cell opener, a surfactant, a cross-linking agent, and a water blowing agent; the polyol-containing composition further includes a cell opener at about 1 parts by weight percent, a surfactant at about 0.5 parts by weight percent, a cross-linking agent at about 1.5 parts by weight percent, and a water blowing agent at about 3 parts by weight percent; the polyol-containing composition further includes greater than or equal to about 9.33 parts by weight percent 2-hydroxyethyl disulfide to less than or equal to about 28 parts by weight percent 2-hydroxyethyl disulfide; the polyurethane foam has a strength at max of greater than or equal to about 186.9 kPa; and a vehicle component is formed of the polyurethane foam.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a plurality of optical microscopy images of the reprocessed polyurethane sheets according to Table 1 after thermal reprocessing.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, “isocyanates” include diisocyanates such as aromatic diisocyanates, toluene diisocyanates (“TDI”), and methylene diphenyl diisocyanates (“MDI”), as well as polyisocyanates, and mixtures thereof. Non-limiting examples of isocyanates include methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), tolidine diisocyanate (TODI), and combinations thereof. It is contemplated isocyanates may include polymeric materials.

As used herein, “polyols” are polymeric polyols which can be used in the practice of the present disclosure and are well known and widely available commercially. Non-limiting examples of polyols include polyether polyol, polyester polyol, polycarbonate polyol, polybutadiene polyol, polyacrylate polyol, and combinations thereof. In other embodiments, the polyols are generally at least about 80% by weight or more of a composition directly or indirectly obtained from a non-renewable resource such as petroleum; or at least about 80% by weight or more of a composition directly or indirectly obtained from a renewable resource such as bio-based oil (which, as used herein, include vegetable oils, including canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, pennycress oil, carnellina oil, and castor oil; animal fats, including lard, tallow, poultry fat, yellow grease, and fish oil; algae oil, including Nannochloropsis, Spirulina, Chlorella; algae, such as red algae-Rhodophyta, red algae, Pithophora oedegonia, green algae, among others; and polyols made from the bio-based diols 1,3-propanediol (PDO) and 1,4-butanediol (BDO) and diacids, including succinic acid and larger acids such as Elevance's Inherent C18 octadecanedioic acid (ODDA); or blends of compositions directly or indirectly obtained from both petrochemical and bio-based resources. The mechanical properties of the resultant polyurethane foam may depend on the consistency of the polyol. More specifically, higher molecular weight polyols generally form more flexible polyurethanes, whereas lower molecular weight polyols generally form more rigid polyurethanes. One desirable polyol is a petroleum-based polyether, polyoxyethylene glycols Voranol 4701, available from Dow Chemical. It is contemplated that the polyols can be a mixture of two or more different types of polyols.

As used herein, “disulfide reactive chemical” or “disulfide” is a monomer or oligomer that contains disulfide bonds and reactive hydrogens of functionality equal to two or higher. One desirable disulfide reactive chemical is 2-hydroxyethyl disulfide (HEDS), a disulfide diol, but it is contemplated that other disulfide reactive chemicals containing amino, phenol, or carboxy groups including, but not limited to, 4-hydroxyphenyl disulfide, 3,3′-dihydroxydiphenyl disulfide, 2,2′-dithiodiacetic acid, 3,3′-dithiodipropionic acid, or 4,4′-dithiodibutyric acid, 4-aminophenyl disulfide, 2-aminophenyl disulfide, 2,2′-dithiodibenzoic acid, cystamine, cystine, L-Glutathione oxidized, polymerized disulfide oligomers (also known as polysulfide derivatives, such as polysulfide diglycidyl ether), as well as mixtures thereof, may be suitable for preparing the polyurethane foams disclosed herein.

As noted above, polyurethane foams are typically prepared by reacting isocyanates with polyols in the presence of additives. In such a manner, it is contemplated that a polyol solution according to the present disclosure includes at least a polyol, a disulfide reactive chemical, and any desired additives. Such additives, some of which may be optional, include at least one of a cell opener, a surfactant, a cross-linking agent, a catalyst, and a water blowing agent. It is also contemplated that a polyol solution may include a polyol, disulfide reactive chemical, reinforcements, and any desired additives.

Blowing agents assist in preparing foam, and water is highly desirable as a blowing agent. Other blowing agents suitable according to the present disclosure include fluorocarbons, hydrochlorocarbons, chorofluorocarbons, hydrofluorocarbons, hydrocarbons. It is also contemplated that gas may be added directly to the polyol isocyanate reaction mixture to form the foam.

Surfactants are useful for cell nucleation and cell opening in foam applications and offer foam stabilization. One desirable surfactant is TEGOSTAB® B 4690, available from Evonik Degussa, but it is contemplated other nonionic surfactants may be suitable for preparing the polyurethane foams disclosed herein.

Cross-linking agents may be used to control flexural and other properties of the foam. Suitable cross-linking agents include diethanolamine (DEA) and triethanolamine, which, when used in foam application, build firmness, and increase catalytic activity.

Catalysts enhance the processing characteristics and physical properties of polyurethane foams by promoting the basic chemical reactions between polyol and isocyanate, reactions between water and isocyanate, and reactions to trimerizate isocyanates. Catalysts may be selected according to the needs of a particular application, for example, to improve the flexible foaming process of a wide variety of foams, including high-density unfilled foam, filled foam, high load-bearing flexible foam, low-density foam, and high resilience molded foam. Other catalysts may be selected to delay the foam-forming reaction process, which can result in more open foam structures. Suitable catalysts according to the present disclosure are diluted amine ethers, such as NIAX® A1 and liquid, water-soluble tertiary amines, such as NIAX® A-300, each of which is available from Momentive Performance Materials. Tertiary amines may be desirable as catalysts when water is present in the polyol isocyanate reaction mixture, as it catalyzes the isocyanate to react with water to form urea linkages with urethane. Yet another catalyst is dibutyltin dilaurate (BDTDL). According to a form, the catalyst may comprise a first catalyst comprised of a diluted amine ether, and a second catalyst comprised of a water-soluble tertiary amine.

Cell openers may be used to prepare foam structures that have predominantly open cells, which gives it a larger value of air permeability and include water-soluble emulsifiers, such as LUMULSE® POE (26) GLYC, available from Vantage Specialty Chemicals, Inc.

Other optional additives include buffers, dendritic macromolecules, inorganic particulates, other types of polyols not listed herein, polyisocyanates, flame retardants, deodorants, colorants, fillers, combinations thereof, and other additives known to those familiar with the technology.

Disulfide-Based Polyurethane Foams

Disulfide-based foams (Sample 1-3) of different HEDS content (9.3 phr, 18.6 phr, and 27.9 phr on the basis of polyol) as shown below in Table 1 were prepared and tested according to the teachings of the present disclosure. A foam without using HEDS was also prepared as a reference (control). The catalyst and co-catalyst amounts are generally based on the molar composition of the isocyanate (M(NCO)) (i.e., whether the catalyst was 0.6 phr, 0.77 phr, 0.93 phr, or 1.09 phr on the basis of polyol, or whether co-catalyst was 0.3 phr, 0.39 phr, 0.47 phr, or 0.55 phr on the basis of polyol). The molar ratio of active hydrogens (M(H)) to isocyanate groups (M(NCO)) of all compositions was fixed at 1:1. The active hydrogens count those in the hydroxyl groups of polyol and HEDS (or other disulfide), hydroxyl and active amine groups of cross-linking agent, and the two hydrogen groups of water.

TABLE 1
Example/Test Compositions of Disulfide-based Polyurethane
Foams and Control in Parts by Weight Percent

| Chemical | Control | Sample-1 | Sample-2 | Sample-3 |
|---|---|---|---|---|
| Polyol (Polyether | 100 | 100 | 100 | 100 |
| polyol) | | | | |
| Cell opener | 1 | 1 | 1 | 1 |
| Surfactant | 0.5 | 0.5 | 0.5 | 0.5 |
| Crosslinker (DEA) | 1.5 | 1.5 | 1.5 | 1.5 |
| Catalyst | 0.6 | 0.77 | 0.93 | 1.09 |
| Co-Catalyst | 0.3 | 0.39 | 0.47 | 0.55 |
| Disulfide reactive | 0 | 9.3 | 18.6 | 27.9 |
| chemical (HEDS) | | | | |
| Blowing agent | 3 | 3 | 3 | 3 |
| (Water) | | | | |
| Isocyanate | 51.4 | 72.1 | 87.7 | 108.3 |

The working examples were produced according to the following procedure. First, a polyol mixture was formed by mixing together up to about 100 parts by weight percent polyether polyol (e.g., VORANOL® 4701, available from Dow Chemical Co.), about 1 parts by weight percent cell opener (e.g., LUMULSE® POE (26) GLYC available from Lambent Corporation), about 0.5 parts by weight percent surfactant (e.g., TEGOSTAB® B4690, available from Evonik Nutrition & Care GmbH), about 1.5 parts by weight percent cross-linking agent (e.g., DEA), at least about 0.6 parts by weight percent of a first catalyst (e.g., NIAX® A1, available from Momentive Performance Materials) and at least about 0.3 parts by weight of a second catalyst (e.g., NIAX® A300, also available from Momentive Performance Materials), about 3 parts by weight percent blowing agent (e.g., deionized water), and at least about 9.3 parts by weight percent HEDS with a drill mixer at 1500 rpm for five minutes. The weight concentrations of the catalysts and HEDS are based on the polyether polyol weight in the formulation. As such, after the isocyanate is added, the weight concentration of HEDS in the resultant foams is greater than about 4.93 parts by weight percent, and, as examples, may be at about 8.71 parts by weight percent, and about 11.72 parts by weight percent. A methylene diphenyl diisocyanate (MDI) (e.g., RUBINATE® 7304, available from Huntsman International LLC) was added to the polyol mixture and mixed with the mixer at 1500 rpm for 12 seconds. The reaction mixture was poured into a closed mold system that had been coated with Chem-Trend PU-11331 release agent and warmed in a pre-heated oven at 65° C. for 8 minutes to allow for rising, modeling, and curing. The demolded foams were then place in a ventilation oven pre-heated at 65° C. for 2 hours and subsequently removed from the oven and then conditioned at room temperature for a minimum of 48 hours.

The resultant foams of the working examples shown in Table 1 had their apparent density tested according to ASTM D3574, Test A; their compression force deflection tested according to ASTM D3574-08, Test C; their tensile strength at break tested according to ASTM D3574-08, Test E; and their elongation at max load tested according to ASTM D3574-08, Test E. Five samples were measured for each test, and the results were averaged. Table 2 below shows the results of the respective tests. (Parentheticals represent standard deviation).

TABLE 2
Mechanical Properties of Compositions Formed According to Table 1

| | Tensile | | Strength | | Elongation | | | | Specific | Specific |
|---|---|---|---|---|---|---|---|---|---|---|
| | Modulus | | at max | | at break | | Density | | strength | modulus |
| Sample | (kPa) | | (kPa) | | (%) | | (kg/m³) | | (kNm/kg) | (kNm/kg) |
| Control | 197.1 | (9.9) | 135.6 | (10) | 73.3 | (8.5) | 51.7 | (2.6) | 2.62 | 3.81 |
| Sample-1 | 405.2 | (40.9) | 186.9 | (20.1) | 64.7 | (9.2) | 56.2 | (2.8) | 3.32 | 7.2 |
| Sample-2 | 755.6 | (57.7) | 264.6 | (19.1) | 58.5 | (9.8) | 60 | (2.7) | 4.41 | 12.59 |
| Sample-3 | 1125.8 | (144.6) | 263.4 | (24.5) | 48.6 | (3.3) | 65.5 | (1.2) | 4.02 | 17.18 |

As shown in Table 2, the control foam exhibited more flexibility but is weaker than the disulfide-based foam. The disulfide-based foams are also more rigid than the control foam at room temperature, but each of the disulfide-based foams was still in the rubber state of their soft domains (polyol). The disulfide-based foams were somewhat denser than the control foam, but their density can be further manipulated by changing the volume ratio of the reactant mixture versus the mold size (space).

The resultant foams of the working examples shown in Table 1 also had compression properties tested. Table 3 below shows the results of the respective tests.

TABLE 3
Compression Properties of Compositions Formed According to Table 1

| | | | Stress at | Stress at | Stress at |
|---|---|---|---|---|---|
| | Modulus | Stress at | 25% strain | 50% strain | 65% strain |
| Sample | (kPa) | max (kPa) | (kPa) | (kPa) | (kPa) |
| Control | 75.3 | 17.52 (1.11) | 5.96 (0.24) | 8.78 | 13.75 |
| | (11) | | | (0.43) | (0.79) |
| Sample | 96.4 | 22.24 (0.99) | 7.83 (0.59) | 11.39 | 17.87 |
| -1 | (13.1) | | | (0.88) | (1.17) |
| Sample | 267.8 | 51.58 (2.8) | 14.61 (1.82) | 23.26 | 39.2 |
| -2 | (32.2) | | | (1.94) | (2.0) |
| Sample | 366.5 | 74.42 (5.72) | 21.52 (2.72) | 34.95 | 57.53 |
| -3 | (47.9) | | | (3.65) | (4.78) |

As shown in Table 2, the disulfide-based foams were stiffer than the control foam and accordingly offered better support under stress than the control foams. The HEDS contributed to the hard domains of the polyurethane network and resulted in increases in compression properties.

The HEDS, which was integrated into the hard domain of a cross-linked network by its reaction with MDI isocyanate, functioned as a dynamic covalent mechanism and modified the flexible polyether-based polyurethane foam. Addition of HEDS resulted in a synergistic effect of disulfide bonds and increased carbamate content (by diol-isocyanate reaction) for enabling vitrimer chemistry in polyurethane foams. In this manner, the HEDS also acted as a chain extender that reduced the second glass transition temperature and increased chain mobility at a processing temperature of 150° C., which further facilitated the thermal processing of the polyurethane foams.

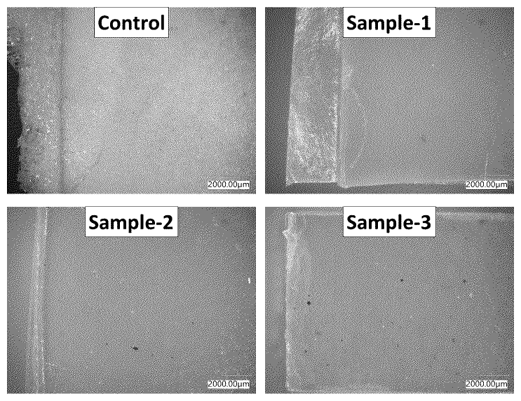

The foams prepared according to Table 1 were then subject to thermal processing. More specifically, the foams were torn into twenty pieces of irregular shape and size and then subjected to a hot-pressing process under a 15 MPa press and 150° C. temperature for 60 minutes, which included the time required for gradual loading of the fragmented pieces. In this process, the foam was transformed to solid sheet products by compression molding. FIG. 1 shows the optical microscopy images of the reprocessed polyurethane sheets.

As shown in FIG. 1, the disulfide-based foams (Sample 1-3) were finely converted to compact and homogenous sheets (as disulfide-based sheets) after thermal reprocessing, indicating great vitrimer-induced malleability. A thermoplastics-like phenomenon occurred for these foams during the thermal reprocessing. More specifically, excessive material was forced out of the mold, as the disulfide-based foams exhibited fluidlike behavior. The control foam was not densified into a homogeneous and compact sheet (as control sheet) since it retained thermoset properties and high elasticity that limited reprocessability. The control sheet thereby displayed a large amount of remaining non-densified cellular structures that worked as internal cracks and voids.

Reprocessed polyurethane sheets were subjected to density, tensile (included modulus, strength at break, elongation at break, specific strength, and specific modulus), and Shore A hardness testing according to ASTM D792-20, D412-16, D2240-15, respectively. Five samples were measured for each test, and the results were averaged. Table 4 below shows the results of the respective tests. (Parentheticals represent standard deviation).

TABLE 4
Mechanical Properties of Reprocessed Sheets Formed According to Table 1 After Thermal Reprocessing

| | | | | | | | Strength | | Elongation | | Specific | | Specific | |
|---|---|---|---|---|---|---|---|---|---|---|---|---|---|---|
| | Density | | Shore A | | Modulus | | at break | | at break | | strength | | Modulus | |
| Sample | ( g/cm³) | | Hardness | | (MPa) | | (MPa) | | (%) | | (kNm/kg) | | (kNm/kg) | |
| Control | 0.98 | (0.06) | Not Applicable (due to inhomogeneous sample integrity) | | | | | | | | | | | |
| Sample-1 | 1.05 | (0.03) | 89.1 | (1.1) | 31.0 | (3.2) | 14.1 | (0.8) | 98.9 | (8.8) | 29.5 | (0.3) | 13.3 | (0.8) |
| Sample-2 | 1.10 | (0.02) | 92.7 | (1.0) | 68.4 | (10.3) | 12.9 | (1.1) | 78.7 | (18.4) | 62.2 | (0.9) | 11.7 | (1.0) |
| Sample-3 | 1.12 | (0.02) | 95.5 | (0.6) | 120.4 | (20.1) | 10.3 | (1.5) | 44.3 | (6.8) | 107.5 | (1.8) | 9.2 | (1.2) |

As shown in Table 4, the disulfide-based sheets retained much of their mechanical properties after thermal reprocessing, whereas the control sheet quickly lost its mechanical properties that being even infeasible for the mechanical testing (inhomogeneous sample integrity). Particularly, all disulfide-based sheets showed decent modulus, strength, and Shore A hardness that could be comparable with some commercialized sulfur-vulcanized rubber or polyurethane elastomer products. Without wishing to be bound by theory, it is believed that the vitrimerization of the flexible polyether-based polyurethane foams allowed for the disulfide-based foams to act more as thermoplastics at a high temperature. In contrast, the control foams retained their thermoset properties and displayed poor malleability and processability under the same processing condition. As such, it is believed that the disulfide-based foams could be recycled by traditional processing techniques like hot-press, whereas that is not practically feasible with the control foams without HEDS or other disulfide reactive chemicals. Moreover, it appears that the HEDS reduces the glass transition temperature of the hard domain (from ˜200° C. to ˜160° C.) and further promotes molecular mobility at a certain processing temperature like 140˜160° C., which accordingly provides even better recyclable and reusable properties

Also, based on the results of Table 4, excessive amounts of HEDS (such as greater than or equal to about 27.9 phr to polyol) may not be as desirable, as samples made with such amounts did not allow for optimum reproducibility reflected by a reduced mechanical strength.

The polyurethane foams disclosed herein may be used in various applications where it is desirable to have foams having the properties disclosed herein, e.g., such as foams for the furniture industry. Further, the polyurethane foams disclosed herein may be used in various automotive applications and for vehicle components, including but not limited to seat backs, arm rests, seat cushions, headliner applications, head rests, NVH (noise, vibration, and harshness) foams, engine covers, oil pump covers, air conditioning compression covers, fuel covers, and under the hood covers.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A polyurethane foam produced by reacting a polyol-containing composition and an isocyanate composition, wherein the polyol-containing composition comprises greater than or equal to about 9.33 parts by weight percent disulfide reactive chemical to less than or equal to about 28 parts by weight percent disulfide reactive chemical.

2. The polyurethane foam according to claim 1, wherein the polyurethane foam further comprises at least one of a cell opener, a surfactant, a cross-linking agent, a catalyst, a co-catalyst, and a water blowing agent.

3. The polyurethane foam according to claim 1, wherein the polyol-containing composition further comprises:
a cell opener at about 1 parts by weight percent;
a surfactant at about 0.5 parts by weight percent;
a cross-linking agent at about 1.5 parts by weight percent;
a catalyst at greater than or equal to about 0.7 parts by weight percent;
a co-catalyst at greater than or equal to about 0.35 parts by weight percent; and
a water blowing agent at about 3 parts by weight percent.

4. The polyurethane foam according to claim 1, wherein the polyol-containing composition comprises a catalyst at greater than or equal to about 0.7 parts by weight percent to less than or equal to about 0.87 parts by weight percent and a co-catalyst at greater than or equal to about 0.35 parts by weight percent to less than or equal to about 0.44 parts by weight percent.

5. The polyurethane foam according to claim 1, wherein the polyurethane foam has a strength at max of greater than or equal to about 186.9 kPa.

6. The polyurethane foam according to claim 1, wherein the polyurethane foam has a density of greater than or equal to about 56.2 kg/m³.

7. A vehicle component comprised of the polyurethane foam of claim 1.

8. A polyurethane foam produced by reacting a polyol-containing composition and an isocyanate composition, wherein the polyurethane foam comprises greater than or equal to about 5.5 parts by weight percent 2-hydroxyethyl disulfide and the polyol-containing composition comprises a catalyst at greater than or equal to about 0.7 parts by weight percent to less than or equal to about 0.87 parts by weight percent.

9. The polyurethane foam according to claim 8, wherein the polyurethane foam further comprises at least one of a cell opener, a surfactant, a cross-linking agent, a co-catalyst, and a water blowing agent.

10. The polyurethane foam according to claim 9, wherein the polyol-containing composition further comprises:
a cell opener at about 1 parts by weight percent;
a surfactant at about 0.5 parts by weight percent;
a cross-linking agent at about 1.5 parts by weight percent;
a co-catalyst at greater than or equal to about 0.35 parts by weight percent; and
a water blowing agent at about 3 parts by weight percent.

11. The polyurethane foam according to claim 9, wherein the polyol-containing composition comprises a co-catalyst at greater than or equal to about 0.35 parts by weight percent to less than or equal to about 0.44 parts by weight percent.

12. The polyurethane foam according to claim 9, wherein the polyurethane foam has a specific modulus of greater than or equal to about 7.20 kNm/kg.

13. The polyurethane foam according to claim 9, wherein the polyurethane foam has a specific strength of greater than or equal to about 3.32 kNm/kg.

14. A vehicle component comprised of the polyurethane foam of claim 9.

15. A polyurethane foam produced by reacting a polyol-containing composition and an isocyanate composition, wherein the polyol-containing composition comprises 2-hydroxyethyl disulfide, a catalyst at greater than or equal to about 0.7 parts by weight percent, and a co-catalyst at greater than or equal to about 0.35 parts by weight percent.

16. The polyurethane foam according to claim 15, wherein the polyurethane foam further comprises at least one of a cell opener, a surfactant, a cross-linking agent, and a water blowing agent.

17. The polyurethane foam according to claim 15, wherein the polyol-containing composition further comprises:
a cell opener at about 1 parts by weight percent;
a surfactant at about 0.5 parts by weight percent;
a cross-linking agent at about 1.5 parts by weight percent; and
a water blowing agent at about 3 parts by weight percent.

18. The polyurethane foam according to claim 15, wherein the polyol-containing composition further comprises greater than or equal to about 9.33 parts by weight percent 2-hydroxyethyl disulfide to less than or equal to about 28 parts by weight percent 2-hydroxyethyl disulfide.

19. The polyurethane foam according to claim 15, wherein the polyurethane foam has a strength at max of greater than or equal to about 186.9 kPa.

20. A vehicle component comprised of the polyurethane foam of claim 15.
